(19) United States
(12) Patent Application Publication
(10) Pub. No.: US 2014/0021126 A1
(43) Pub. Date: Jan. 23, 2014

(54) REVERSIBLE BACKWASHING SELF-CLEANING FILTER

(71) Applicants: Deng Hong Luo, Heng Yang (CN); Wen Bin Liu, Bao Jing (CN); Yong Huang, Heng Yang (CN); Qing Huang, Shenzhen (CN)

(72) Inventors: Deng Hong Luo, Heng Yang (CN); Wen Bin Liu, Bao Jing (CN); Yong Huang, Heng Yang (CN); Qing Huang, Shenzhen (CN)

(73) Assignee: Dan Lin, Shenzhen (CN)

(21) Appl. No.: 13/551,814

(22) Filed: Jul. 18, 2012

(51) Int. Cl. B01D 29/68

(52) U.S. Cl. 210/333.01

(57) ABSTRACT

The present invention relates to a reversible backwashing self-cleaning filter, including a filter mechanism, a backwashing drive mechanism driving a sewage suction assembly, and a high-pressure washing apparatus. The high-pressure washing apparatus includes a high-pressure washing pump and at least one high-pressure branch pipe arranged along the outer wall of the fine strainer and operating synchronously with the sewage suction assembly, where a plurality of spray nozzles are spacedly arranged where the high-pressure branch pipe is opposite to the outer wall of the fine strainer. With collaboration of translation and rotation of the sewage suction assembly, the inner and outer walls of the entire fine strainer are thoroughly cleaned, suitable for real-time purification of a low-pressure water circulating system.

### BACKGROUND OF THE INVENTION

1. Field of the Invention

The present invention relates to a filter for water purification in an industrial circulating water system, and in particular, to a self-cleaning filter capable of automatically cleaning sewages and foreign substances deposited on the strainer.

2. Background

For working principles of the filter for real-time purification of circulating water for industrial use, the basic structure of the filter is as shown in FIG. 1. Specifically, raw water is led into a coarse filter cavity 103 from a water inlet 101, foreign substances with large particles in the raw water are filtered and intercepted by a coarse strainer 102, the raw water then flows into a fine filter cavity 104 and further filtered by a fine strainer 105, and then the water is led out from a water outlet 106. After a period of filtering, a layer of foreign substances and dirt is generally deposited on the inner wall of the fine strainer 105, producing an increasing pressure difference between the interior and exterior of the fine strainer 105. If this pressure different is too large, the filter speed may be affected. Accordingly, a sewage suction assembly 201 is arranged along the direction of the axial center inside a cylinder fine filter cavity enclosed by the fine strainer 105; a plurality of suction nozzles 202 are arranged on the sewage suction assembly 201; a speed reduction machine 301 arranged in a backwashing drive mechanism 3 drives a connection rod 303 on a transmission screw rod 301 of the speed reduction machine; the sewage suction assembly 201 is fixedly connected to the connection rod 303; during backwashing, i.e., sewage discharging; a solenoid sewage disposal valve 114 is automatically switched on; the sewage suction assembly 201, under the drive of the speed reduction machine 301, spirally moves upward (translates or rotates) along the axial direction of the fine strainer and the sewage suction assembly through the connection rod 303 on the screw rod 301 and the sewage suction assembly 201; the suction nozzles 202 synchronously operates with the sewage suction assembly 201; when the solenoid sewage disposal valve 114 is switched on, the pressure inside a sewage disposal cavity 108 sharply decreases, and the sewage disposal cavity 108 is communicated with a fine filter cavity 104 through the sewage suction assembly 201 and the suction nozzles 202. In this way, the pressure of the sewage disposal cavity 108 against the fine filter cavity 104 also encounter a synchronous sharp decrease, producing a pressure difference between the sewage disposal cavity 108 and the fine filter cavity 104. In this manner, thorough suctioning and cleaning of the foreign substances adhering on the inner wall of the fine strainer 105 are implemented by using the suction nozzles 202. During such backwashing process, the water flow is not interrupted, and therefore, continuous and automatic working is implemented.

The main defect of the above-described backwashing apparatus lie in that: When the filter has been used for a long time, foreign substances, dirt and adhesive deposits that are hard to be suctioned by the suction nozzles 202 on the sewage suction assembly 201 are formed on the fine strainer; if the suction power of the suction nozzles 202 is insufficiently great, the foreign substances deposited with time going by may affect the automatic cleaning effect and lifecycle of the self-cleaning filter; especially in a raw water system with low pressure, the pressure different between the sewage disposal cavity 108 and the fine filter cavity 104 is small, and the suction power of the suction nozzles 202 is insufficient to clear the foreign substances, thereby causing a poor backwashing effect of the filter and a degraded performance after a long period of use.

In view of the above, the Chinese patent application No. 200810217079.8 filed on Oct. 24, 2008 and published on Apr. 8, 2009 with the publication No. CN101402010A has disclosed an electrically-controlled washing apparatus for self-cleaning filter. In the filter, an apparatus for spraying the water flow to the inner wall of the fine strainer is additionally arranged in the sewage suction assembly. The suction nozzles 202 spray high-pressure water flow to the inner wall of the fine strainer to wash various foreign substances adhering on the inner wall of the fine strainer; the filter is then backwashed by means of suction to improve the backwashing effect.

However, even such backwashing apparatus is additionally arranged, firstly, because the direction of the adhesion force of the foreign substances and dirt on the inner wall of the fine strainer is generally from interior to exterior, which is the same as the direction of the high-pressure water flow for washing the fine strainer. Therefore, part of the foreign substances and dirt adhering on the inner wall of the fine strainer, especially when the adhesion is strong, are hard to be loosen or washed away and suctioned by the suction nozzles 202 and cleared during the process of high-pressure washing. In addition, the outer wall of the fine strainer in the filter is always not washed during the backwashing process, and various substances or deposits adhering on the outer wall of the fine strainer are not cleared. After the filter is used for a long time, the filter effect is also affected. Finally, in the low-pressure raw water system, the defect that such filter has a poor backwashing effect is still not effectively addressed.

### SUMMARY OF THE INVENTION

Directing to the defects in the prior art, the present invention provides a reversible backwashing self-cleaning filter for effectively cleaning foreign substances and deposits on the strainer and improving filter efficiency.

According to the present invention, the technical solution to solve the above-mentioned technical problem is a reversible backwashing self-cleaning filter, including a filter mechanism, a suction scanner assembly, and a backwashing drive mechanism;

where the filter mechanism includes a water inlet, a coarse strainer, a coarse filter cavity, a fine filter cavity, a fine strainer, and a water outlet; where raw water is led in from the water inlet, flows through the coarse strainer into the coarse filter cavity, enters the fine filter cavity from the coarse filter cavity, and is led out from the water outlet after a secondary filter by the fine strainer;

the sewage suction assembly is arranged at the center of the fine strainer, and communicated with a sewage disposal cavity though a sewage suction pipe, and the sewage suction pipe is spacedly provided with a plurality of suction nozzles for suctioning deposits on the inner wall of the fine strainer;

the backwashing drive mechanism rotatingly drives the sewage suction assembly to enable the suction nozzles to rotate around the inner wall of the fine strainer;

the reverse backwashing self-cleaning filter further includes a high-pressure washing apparatus, the high-pressure washing apparatus including a high-pressure washing pump and at least one high-pressure branch pipe arranged along the outer wall of the fine strainer and operating synchronously with the sewage suction assembly, where a plurality of spray nozzles are spacedly arranged where the high-pressure branch pipe is opposite to the outer wall of the fine strainer, and water from the high-pressure washing pump, applied with pressure by the high-pressure branch pipe, is sprayed through the plurality of spray nozzles towards the outer wall of the fine strainer.

Each of the plurality of suction nozzles is corresponding to each of the plurality of spray nozzles, and correspondingly arranged on the inner wall and the outer wall of the fine strainer.

The backwashing drive mechanism rotatingly drives the sewage suction assembly to enable the suction nozzles to rotate around the inner wall of the fine strainer.

The high-pressure washing apparatus further includes: a high-pressure leading pipe arranged inside the sewage suction pipe; a high-pressure leading tube tightly sleeved inside a first end of the high-pressure leading pipe and capable of sliding against the high-pressure leading pipe; and a transmission connection set, having the three-way streaming function, fixedly arranged on the sewage suction assembly, where one outlet of the transmission connection set is communicated with a second end of the high-pressure leading pipe, and the other two outlets are respectively communicated with the two parallelly arranged high-pressure branch pipes; and the water from the high-pressure washing pump arranged outside the filter are led into the high-pressure pipes through the high-pressure leading tube, the high-pressure leading pipe, and the transmission connection set by turns.

As compared with the prior art, the reversible backwashing self-cleaning filter according to the present invention produces the following beneficial effects: Using the technical solution provided in the present invention, the purified water is sprayed at a high speed from a plurality of spray nozzles, forming a high-speed jet; the direction of the high-speed jet is reverse to that of the water flow in the process of normal filtering; the high-speed jet washes the outer wall of the fine strainer, and washes foreign substances and dirt adhering on the inner wall of the fine strainer and hard to be suctioned by a sewage suction assembly and suction nozzles away from the fine strainer so that the suction nozzles effectively suctions away the deposits washed away; in addition, the high-speed jet washes the outer surface of the fine strainer and meanwhile washes away the deposits formed on the outer surface of the fine strained for a long period of time to that the inner and outer surfaces of the entire fine strainer are thoroughly cleaned; further, with the rotation and translation motions of the sewage suction assembly, spraying and sewage suctioning work collaboratively to ensure that the inner and outer walls of the fine strainer are thoroughly cleaned.

### BRIEF DESCRIPTION OF THE DRAWINGS

FIG. 1 is an overall schematic structural diagram of a reversible backwashing self-cleaning filter according to an embodiment of the present invention;

FIG. 2 is a schematic structural diagram of a high-pressure washing apparatus in the self-cleaning filter according to an embodiment of the present invention; and

FIG. 3 is an exterior schematic structural diagram of the reversible backwashing self-cleaning filter according to an embodiment of the present invention.

### REFERENCE SIGNS AND DENOTED PARTS OR ELEMENTS

101—water inlet;
102—coarse strainer;
103—coarse filter cavity;
104—fine strainer;
105—fine filter;
106—water outlet;
108—sewage disposal cavity;
111—spacer between the coarse filter cavity and the fine filter cavity;
112—spacer plate between the coarse filter cavity and the sewage disposal cavity;
114—sewage disposal valve;
115—sewage disposal pipe;
116—filter bottom plate;
117—filter housing;
118—filter end cover plate;
119—pressure meter and control box;
120—pressure difference inductive switch;
200—sewage suction pipe;
201—sewage suction assembly;
202—suction nozzles;
205—sewage disposal outlet of the sewage suction assembly;
301—speed reduction machine;
302—screw rod;
303—linking lever;
501—high-pressure washing pump;
502—high-pressure soft pipe;
502—high-pressure pipe connector;
504—high-pressure leading tube;
505—high-pressure leading pipe;
506—transmission connection set;
507—high-pressure branch pipes;
508—spray nozzles;
509—connection pin.

### DETAILED DESCRIPTION OF THE INVENTION

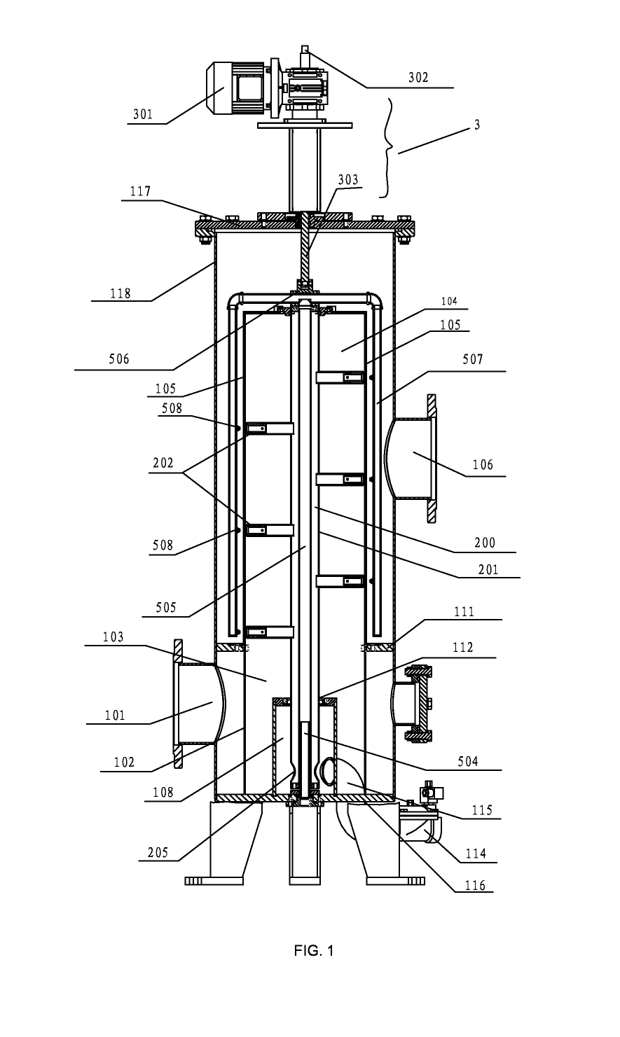

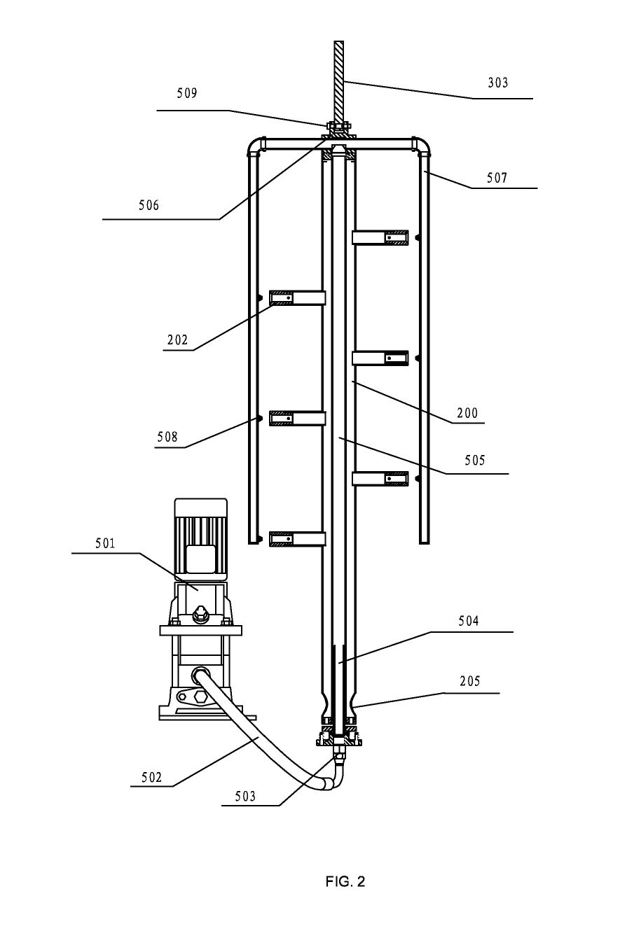

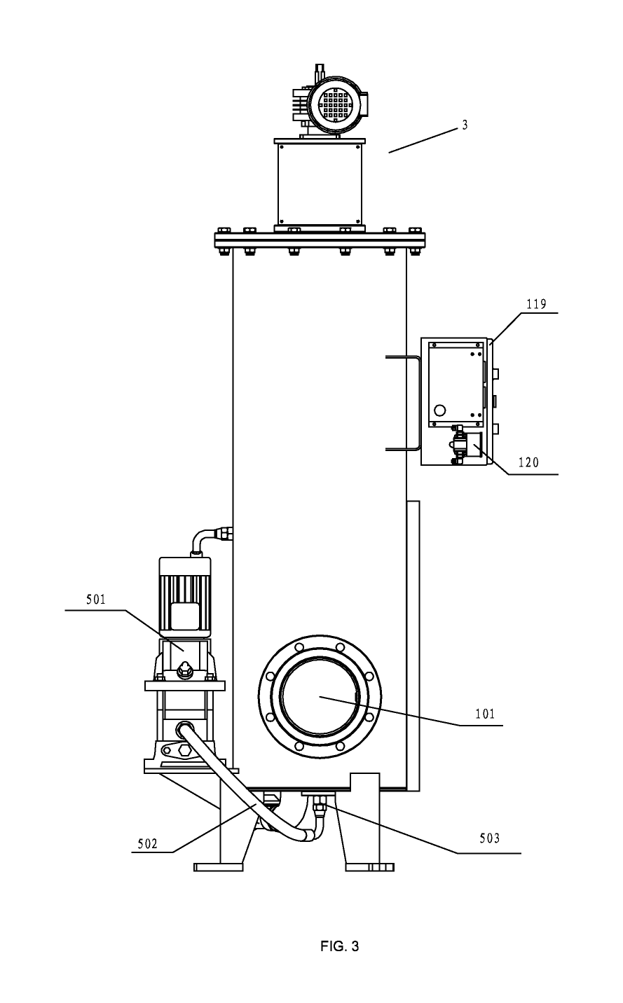

Referring to FIG. 1, FIG. 2, and FIG. 3, the basic structure of a reversible backwashing self-cleaning filter according to the present invention is similar to that in the prior art, mainly including: a filter mechanism, a sewage suction assembly 201, and a backwashing drive mechanism.

The filter mechanism includes a water inlet 101, a coarse strainer 102, a coarse filter cavity 103, a fine filter cavity 104, a fine strainer 105, and a water outlet 106; where raw water is led in from the water inlet 101, flows through the coarse strainer 102 into the coarse filter cavity 103, enters the fine filter cavity 104 from the coarse filter cavity 103, and is led out from the water outlet 106 after a secondary filter by the fine strainer 105. For the specific structure of the filter, reference may be made to FIG. 1 and FIG. 3. Reference sign 111 denotes a spacer plate between the coarse filter cavity and the fine filter cavity, reference sign 112 denotes a spacer plate between the coarse filter cavity and the sewage disposal cavity. Such structural features similar to those in the prior art are not detailed herein again.

The sewage suction assembly 201 is arranged at the center of the fine strainer 105, and communicated with a sewage disposal cavity 108 though a sewage suction pipe 200, and the sewage suction pipe 200 of the sewage suction assembly 201 is spacedly provided with a plurality of suction nozzles 202 for suctioning deposits on the inner wall of the fine strainer 105. In a common structure, as shown in FIG. 1 and FIG. 2, the suction nozzles 202 are arranged evenly and spacedly in two opposite directions, left and right, on the sewage suction pipe 200.

For a better backwashing effect, spacing between neighboring suction nozzles 202 and the number of suction nozzles 202 may be determined according to a combination of the stroke of the screw rod 302, the screw pitch, the rotation speed and the height of the fine strainer to ensure that during translation and rotation of the suction nozzles 202, the foreign substances and dirt adhering on the fine strainer are thoroughly suctioned in a scanning manner and the scanning scope covers every area on the inner wall of the fine strainer without leaving out any. This is simple for those skilled in the art to implement, which is not detailed herein.

The backwashing drive mechanism 3 rotatingly drives the sewage suction assembly to enable the suction nozzles to rotate around the inner wall of the fine strainer. Specifically, a speed reduction machine 301 illustrated in FIG. 1 may be used. The speed reduction machine 301 drives the screw rod 302 to rotate spirally, and a connection rod 303 connected with the screw rod is fixedly connected with the sewage suction assembly 201. In this way, when the fine strainer 105 is back washed, the fine strainer 105 is not automatic, and the suction nozzles 202 and a high-pressure washing apparatus 5 to be described in the following are both fixedly connected with the sewage suction assembly 201. Under drive of the speed reduction machine 301, the sewage suction assembly 201 rotates and translates along the axial direction, and the synchronously operating suction nozzles 202 and spray nozzles 508 are capable of sewage washing and absorption the inner and outer walls of the fine strainer 105 point by point in all directions.

According to the present invention, based on the above-described structure, a high-pressure washing apparatus 5 is further arranged. The high-pressure washing apparatus 5 includes a high-pressing washing pump 501 independently arranged outside the filter. The high-pressure pump 501 is connected with a high-pressure leading tube 504 through a high-pressure soft pipe 502 and a high-pressure pipe connector 503. The other end of the high-pressure leading tube is inserted into the high-pressure leading pipe 505 isolated inside the sewage suction pipe 200 of the sewage suction assembly 201. The high-pressure leading tube is tightly sleeved inside a first end of the high-pressure leading pipe and capable of sliding against a high-pressure leading pipe 505. A transmission connection set 506 having the three-way streaming function is fixedly arranged on the sewage suction assembly 201 for engagement with the sewage suction assembly 201. One outlet of the transmission connection set 506 is communicated with a second end of the high-pressure leading pipe 505, and the other two outlets are communicated with and fixed to the two parallelly arranged high-pressure branch pipes 507 to drive the high-pressure branch pipes 507 to synchronously operate with the sewage suction assembly 201. The high-pressure branch pipes 507 are arranged along the outer wall of the fine strainer 105 and a plurality of spray nozzles 508 are spacedly arranged where the high-pressure branch pipe is opposite to the outer wall of the fine strainer.

The description that the high-pressure leading tube is tightly sleeved inside a first end of the high-pressure leading pipe and capable of sliding against the high-pressure leading pipe 505 refers to that the high-pressure leading tube transmits vertically inside the high-pressure leading pipe 204 along the axial direction and remains liquid-sealed. In this way, it may be ensured that when the sewage suction assembly moves horizontally, the high-pressure washing apparatus 5 performs washing actions in real time.

Working principles and process of the high-pressure backwashing apparatus of the self-cleaning filter are as follows: The high-pressure washing pump 501 is first started, and the high-pressure washing pump 501 is capable of injecting the purified water through the high-pressure soft pipe 502, the high-pressure pipe connector 503 and the high-pressure leading tube 504 into the high-pressure leading pipe 505 arranged inside the sewage suction pipe 200. The water flowing in the sewage suction pipe 200 is isolated from the purified water flowing in the high-pressure leading pipe 505. The high-pressure flow of the purified water respectively flows through the transmission connection set 506 of the sewage suction assembly into the two parallelly arranged high-pressure branch pipes 507 and then sprayed from the plurality of spray nozzles 508 of the high-pressure branch pipes 507, forming a high-speed jet. The high-speed jet washes the outer wall of the fine strainer 105, and washes foreign substances and dirt adhering on the inner wall of the fine strainer and hard to be suctioned by the sewage suction assembly 201 and the suction nozzles 202 away from the fine strainer through the meshes of the fine strainer. Then the nozzles 202 suctions the foreign substances and dirt washed away from the fine strainer, and the foreign substances and dirt are discharged from a sewage disposal outlet 205 of the sewage suction assembly 201 to the sewage disposal cavity 108, and finally discharged by a sewage disposal pipe 115. In addition, the high-speed jet washes the outer wall of the fine strainer and meanwhile washes away the deposits formed on the outer wall of the fine strained for a long period of time. In this way, the inner and outer walls of the entire fine strainer are thoroughly cleaned, i.e., reversible cleaning.

It should be specifically noted that the above-described structure, especially the structure of the high-pressure washing apparatus 5, is merely an exemplary implementation mode of the present invention. This structure is advantageous in that such structure ensures that the filter provided in the present invention is compact and reasonable in structure, more reliable in operation, and parts of the filter do not rub against each other in the motion. It can be understood by those skilled in the art that: The technical solution provided in the present invention differs from the prior art and is capable of achieving the basic objectives and functions of the present invention, as long as the high-pressure branch pipes 507 are arranged on the outer wall of the fine strainer 105 and capable of synchronously operating with the sewage suction assembly, i.e., being fixedly connected but no relative movement and not rubbing against other parts during motion, and the high-pressure branch pipes 507 are capable of receiving the purified water led in by the high-pressure washing pump 501 and washing the outer wall of the fine strainer.

For example, in FIG. 1 and FIG. 2, there are two high-pressure branch pipes 507, and therefore the transmission connection set 506 is used for three-way streaming In practice, if there is only one high-pressure branch pipe 507 or more than two high-pressure branch pipes 507, the transmission connection set 506 may be a common pipe connector or a four-way connector. Modifications and variations according to the actual requirement still achieve the above-described functions and objectives.

Specifically, the high-pressure branch pipes 507 are arranged on the outer wall of the fine strainer 105 and fixedly connected to the sewage suction assembly 201 for engagement with the sewage suction assembly 201. A plurality of spray nozzles are spacedly arranged where the high-pressure branch pipe 507 is opposite to the outer wall of the fine strainer 105. The water from the high-pressure washing pump, applied with pressure by the high-pressure branch pipe, is sprayed through the plurality of spray nozzles towards the outer wall of the fine strainer.

In addition, in the present invention, the connection rod 303 engaged with the screw rod 302 is fixedly connected to the sewage suction assembly 201 to enable the sewage suction assembly 201 to translate along the axial direction while rotating. In practice, the sewage suction assembly 201 is required to rotate, and translation of the sewage suction assembly 201 is optional. The number of suction nozzles may be changed (increased) to achieve thorough scanning absorption.

In a specific embodiment of the present invention, the suction nozzles 202 and the spray nozzles 508 are generally arranged on the inner wall and outer wall of the fine strainer in one-to-one corresponding relationship, as shown in FIG. 2, parellelly and correspondingly arranged against the inner wall and the outer wall of the fine strainer. Such design is to ensure that once the suction nozzles 508 washes the fine strainer, deposit such as the foreign substances and dirt loosing or falling from the inner wall of the fine strainer is closest the suction nozzles 202 and is easily suctioned by the suction nozzles 202 in time and thoroughly, thereby improving the backwashing effect. It can be understood that, in the present invention, as long as the spray nozzles 508 are arranged on the outer wall of the fine strainer, the objective of the present invention can be basically achieved: The water from the high-pressure washing pump, applied with pressure by the high-pressure branch pipe, is sprayed through the plurality of spray nozzles towards the outer wall of the fine strainer. As regard the specific relative positions of the spray nozzles 508 and the suction nozzles 202, for example, opposite and one-to-one corresponding, are more specific technical features.

The backwashing principles and process of the self-cleaning filter may also be understood as follows: The high-pressure washing pump 501 is capable of spraying a strong high-pressure water jet to the outer wall of the fine strainer 105 through the spray nozzles 508. This high-pressure water jet not only enhances the suction ability of the suction nozzles, but also effectively washes away the foreign substances firmly adhering on the fine strainer. The principle lies in that the direction of the force from the high-pressure water jet is reverse to that of the adhesion force of the foreign substances. In this way, the inner and outer walls of the fine strainer are thoroughly cleaned. Even the dirt strongly adhered on the inner wall of the fine strainer 105 or the intercepted material, being washed away or loosing from the inner wall of the fine strainer, may also be suctioned away under the suction force of the suction nozzles 202. In addition, the adhesive deposits on the outer wall of the fine strainer may also fall away from the fine strainer under the strong jet. Meanwhile, with the rotation and translation motions of the sewage suction assembly 201, spraying and sewage suctioning work collaboratively to ensure that the inner and outer walls of the fine strainer are thoroughly cleaned. Further, the washing effect is not affected by the pressure of the water circulating system. Therefore, even during the in-time purification process of the circulating water in the case of low pressure (below 2 Kgf) of the water circulating system, with long-term use, the defect that the back washing and sewage disposal effects are instable is effectively addressed.

What is claimed is:

1. A reversible backwashing self-cleaning filter, comprising a filter mechanism, a suction scanner assembly, and a backwashing drive mechanism; wherein
the filter mechanism includes a water inlet, a coarse strainer, a coarse filter cavity, a fine filter cavity, a fine strainer, and a water outlet; wherein raw water is led in from the water inlet, flows through the coarse strainer into the coarse filter cavity, enters the fine filter cavity from the coarse filter cavity, and is led out from the water outlet after a secondary filter by the fine strainer;
the sewage suction assembly is arranged at the center of the fine strainer, and communicated with a sewage disposal cavity though a sewage suction pipe, and the sewage suction pipe is spacedly provided with a plurality of suction nozzles for suctioning deposits on the inner wall of the fine strainer;
the backwashing drive mechanism rotatingly drives the sewage suction assembly to enable the suction nozzles to rotate around the inner wall of the fine strainer, wherein:
the reversible backwashing self-cleaning filter further comprises a high-pressure washing apparatus, the high-pressure washing apparatus comprising a high-pressure washing pump and at least one high-pressure branch pipe arranged along the outer wall of the fine strainer and operating synchronously with the sewage suction assembly, wherein a plurality of spray nozzles are spacedly arranged where the high-pressure branch pipe is opposite to the outer wall of the fine strainer, and water from the high-pressure washing pump, applied with pressure by the high-pressure branch pipe, is sprayed through the plurality of spray nozzles towards the outer wall of the fine strainer.

2. The reversible backwashing self-cleaning filter according to claim 1, wherein each of the plurality of suction nozzles is corresponding to each of the plurality of spray nozzles, and correspondingly arranged on the inner wall and the outer wall of the fine strainer.

3. The reversible backwashing self-cleaning filter according to claim 1, wherein the backwashing drive mechanism leads the sewage suction assembly by a spiral screw rod to translate and rotate along the axial direction inside the fine strainer.

4. The reversible backwashing self-cleaning filter according to claim 3, wherein: the high-pressure washing apparatus further comprises: a high-pressure leading pipe arranged inside the sewage suction pipe; a high-pressure leading tube tightly sleeved inside a first end of the high-pressure leading pipe and capable of sliding against the high-pressure leading pipe; and a transmission connection set, having the three-way streaming function, fixedly arranged on the sewage suction assembly, wherein one outlet of the transmission connection set is communicated with a second end of the high-pressure leading pipe, and the other two outlets are respectively communicated with the two parallelly arranged high-pressure branch pipes; and the water from the high-pressure washing pump arranged outside the filter are led into the high-pressure pipes through the high-pressure leading tube, the high-pressure leading pipe, and the transmission connection set by turns.
